(19) United States
(12) Patent Application Publication
(10) Pub. No.: US 2021/0004420 A1
(43) Pub. Date: Jan. 7, 2021

(54) POST-RANKER FOR SEARCH RESULTS

(71) Applicant: Microsoft Technology Licensing, LLC, Redmond, WA (US)

(72) Inventors: Manish MITTAL, Redmond, WA (US); Aman SINGHAL, Bellevue, WA (US); Saulo SANTOS, Lynnwood, WA (US); Prithvishankar SRINIVASAN, Seattle, WA (US); Marcelo DE BARROS, Redmond, WA (US)

(73) Assignee: Microsoft Technology Licensing, LLC, Redmond, WA (US)

(21) Appl. No.: 16/460,915

(22) Filed: Jul. 2, 2019

(51) Int. Cl. G06F 16/9535; G06F 16/2457; G06F 16/901; G06F 16/903; G06F 16/951; G06N 5/02

(52) U.S. Cl. CPC G06F 16/9535; G06F 16/24578; G06N 5/02; G06F 16/90335; G06F 16/951; G06F 16/9024

(57) ABSTRACT

Methods and systems are disclosed for post-ranking a ranked search result based on a personal affinity of a user. Issues on ranking a search result of information based on user-level optimization without breaking ranking of the search results based on global optimization functions are addressed by first ranking a search result based on the global optimization functions, followed by post-ranking the ranked search result based on a personal affinity of the user. The personal affinity may be determined based on a search history by the user as captured in a knowledge base. The post-ranking is performed on a limited scope by dividing the ranked search result into multiple portions and re-ranking entries within respective portions based on the personal affinity, for example, by boosting entries that matches the personal affinity to the top of the entries within the portion.

### BACKGROUND

Today, information search tools have become important because of their versatility and convenience in searching for information over the Internet and other networks where a vast amount of information is stored. The information search tools receive a query from the user, search for information based on the query, collect display the search result. As more people use the information search tools to search for information while the total amount of information on the network increases, more important it has become for the user to find information efficiently.

It is with respect to these and other general considerations that the aspects disclosed herein have been made. Also, although relatively specific problems may be discussed, it should be understood that the examples should not be limited to solving the specific problems identified in the background or elsewhere in this disclosure.

### SUMMARY

According to the present disclosure, the above and other issues may be resolved by a post-ranker for search results based on a personal affinity of a user. For example, to optimize a ranking of search results, the methods may include receiving a query input, generating a search result by searching over information storages over the network, ranking the search result based on global optimization functions, determining personal affinity to a category of the user, post-ranking the search result based on the personal affinity, and providing the search result. Moreover, post-ranking of a search result may be facilitated by identifying a personal affinity of the user in a user profile, which is associated with a knowledge. For example, a knowledge base may maintain history logs of user's search activities and classifications of search item by using a graph database.

(To be Added by the Drafter.)

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the description which follows and, in part, will be apparent from the description, or may be learned by practice of the disclosure.

### BRIEF DESCRIPTION OF THE DRAWINGS

Non-limiting and non-exhaustive examples are described with reference to the following figures.

FIG. 1 illustrates an overview of an example system for ranking and post-ranking a search result based on personal affinity in accordance with aspects of the present disclosure.

FIG. 2 illustrates an exemplary component diagram of an information search system in accordance with aspects of the present disclosure.

FIG. 3 illustrates an example of user management table in accordance with aspects of the present disclosure.

FIG. 4 illustrates an example of a query table according to an example system in accordance with aspects of the present disclosure.

FIGS. 5A-5C illustrate data structures of search results with which the disclosure may be practiced in accordance with aspects of the present disclosure.

FIGS. 6A-6C illustrate examples of a user interface to provide search results in accordance with aspects of the present disclosure.

FIGS. 7A-7B illustrate examples of steps of processing a search query according to an example system with which the disclosure may be practiced in accordance with aspects of the present disclosure.

FIG. 8 is a block diagram illustrating example physical components of a computing device with which aspects of the disclosure may be practiced in accordance with aspects of the present disclosure.

FIGS. 9A and 9B are simplified block diagrams of a mobile computing device with which aspects of the present disclosure may be practiced in accordance with aspects of the present disclosure.

FIG. 10 is a simplified block diagram of a distributed computing system in which aspects of the present disclosure may be practiced in accordance with aspects of the present disclosure.

FIG. 11 illustrates a tablet computing device for executing one or more aspects of the present disclosure in accordance with aspects of the present disclosure.

### DETAILED DESCRIPTION

Various aspects of the disclosure are described more fully below with reference to the accompanying drawings, which form a part hereof, and which show specific example aspects. However, different aspects of the disclosure may be implemented in many different forms and should not be construed as limited to the aspects set forth herein; rather, these aspects are provided so that this disclosure will be thorough and complete, and will fully convey the scope of the aspects to those skilled in the art. Aspects may be practiced as methods, systems or devices. Accordingly, aspects may take the form of a hardware implementation, an entirely software implementation or an implementation combining software and hardware aspects. The following detailed description is, therefore, not to be taken in a limiting sense.

The present disclosure provides systems and methods for post-ranking information search results based on personal affinity. Information search service, web search services for example, can provide a ranked list of information in response to receiving input query from the user. Search services may provide a global optimization function to select and rank documents as a search result. The global optimization function(s) may be based on various parameters. Examples of the various parameters may include accurately interpreting the input query, efficiently searching through a vast amount of information stored at web sites over the Internet, and by applying machine language algorithms to globally rank the top documents from the Internet. The global optimization may also take into account locations, overall context of geographically and culturally-specific markets and languages, and a super-fresh content that is the most recent information. For example, the latest-developing news available on the Internet may be the most recent information.

While the global optimization functions of information search services improve accuracy of search results based on query inputs, there are issues of optimizing search results at user level based on personal affinity or category of the user. The personal affinity may be a preference or a category of preference of the user who provides a query for search. As personal affinities may depend on individual users, in some aspects, the systems and methods may leverage the performance of the global optimization functions by first rank a search result based on the global optimization functions and then re-rank or post-rank the ranked search result according to a personal affinity in a category that is specific to the user.

To address issues that relate to ranking search results based on both at the global aspects and the user-level aspects, the systems and methods for post-ranking search results provides post-ranking of search results based on a personal affinity after ranking search results based on the global optimization functions.

In some aspects, a personal affinity may be determined based on selections of predefined preference categories by the user. In some other aspects, the personal affinity may be determined based on analyzing history logs of query inputs, selections of specific documents and/or information from search results and affiliation of the user as stored in user profiles. Alternatively or additionally, knowledge bases implemented in a graph database may be used to identify the category of user preference by efficiently traversing nodes that provide category types and values through links. Graph databases for knowledge bases provide high performance in returning search information by efficiently traversing information stored in the graph. A graph database consists of nodes that are interconnected by edges. Various types of nodes may be stored in a graph database. User profiles for respective users and search requestors may be associated with the knowledge bases. The knowledge bases may maintain history logs of user's search activities and/or classifications of search items. For example, a user may search for information by providing queries that contain words “CSS” and “cascading,” traversing a category of technical aspects may be inferred by the knowledge base as a common category of the terms. In some aspects, entities from query inputs may be extracted before storing the entities in the graph databases. As a technical term for the sole purpose of illustrating the example here, “CS S” may stand for a Cascading Style Sheet, which is a name of technology used to define layout styles for rendering contents on a webpage.

In some aspects, ranking information in a search result based on personal affinity may be performed as a post-ranking function after ranking a search result based on the global optimization functions. Performing the rankings based on the global optimization functions and the user-level optimization functions as separate steps may prevent the systems and the methods from become excessively complex and process-intensive. The ranking based on the global optimization functions may be performed by centralized servers while the post-ranking using the user-level optimization functions based on personal affinity to a certain categories may be performed on computing devices that the user may be operating, thereby distributing the required processing.

To leverage the search result based on the global optimization functions, the post-ranking of the search result based on a personal affinity may be performed in a way not to substantially break the original ranking for the search result while re-ranking the search result. In some aspects, the re-raking or post-ranking of the search result may be performed within each portion of a ranked list of a search result by dividing the ranked list into multiple portions. For example, a ranked (ordered) list of the search result may be divided into three portions: a first portion that includes results with the highest relevance to the query input (e.g., the top three items on the list), a second portion that includes results with the intermediate level of relevance to the query input (e.g., the next three items on the list), and a third portion that includes results with the lowest level of relevance to the query input (e.g., the next three items on the list). Then, the post-ranking may be performed according to personal affinity within respective portions. By limiting the scope of re-ranking operations within respective portions, the post-ranked search result may retain the original ranking based on the global optimization functions at least at the level of portions while “boosting” ranking of information that is relevant to the query input based on personal affinity within respective portions. In some other aspects, the post-ranking that includes re-ranking across adjacent portions may be allowed to increase effects of re-ranking based on personal affinity.

In some aspects, a search result may be provided without the user logged in or use as a guest user without identifying a specific person. When there is no identification about the user, the systems and the methods may provide a search result based on the global optimization functions, without post-ranking the search result based on personal affinity. When more than one distinct user provide the same query input with respective users having distinct personal affinities, the systems and the methods may provide distinct ranked search results according to respectively distinct personal affinities.

In aspects, the post-ranking based on personal affinity may be performed when a set of conditions are satisfied. The set of conditions may include but not limited to: whether a user is logged in for identifying the user's affinity to a particular category, whether the user's affinity to the particular category is identified; whether an intent of a query input matches with the user's affinity, and whether a ratio of information that is classified in the same affinity as the user's affinity to other information in the search results is greater than a predefined threshold. An intent of a query input may be determined by analyzing the query input by applying technologies based on natural language processing and use of a knowledge base for classification. In some other example, suppose the predetermined threshold is predetermined as at 50%, and the search result shows seven out of a total of ten entries information being classified as Technology. The post-ranking operation based on personal affinity to a category of Technology may be performed because having the seven out of ten entry information is higher than the predetermined threshold of the 50%.

There is an issue in personalizing web search results in search engines while also taking into account ranking of information as a search result based on the global optimization of web rankers. The global optimization functions may generate a ranked list of information as a search result based on relevance to the user's intent as determined by analyzing the query input and/or category of information being retrieved as a web search result. Post-ranking the ranked list of information based on a personal affinity of the user within respective portions on the list may generate a re-ranked list with subtle changes. However, the subtle boosting of ranks based on user preference may improve page click rates, reduce quick-back of page navigations and reduce time to provide a ranked list that matches with the user's intent without repeating search operations.

It is with respect to these and other general considerations that embodiments have been made.

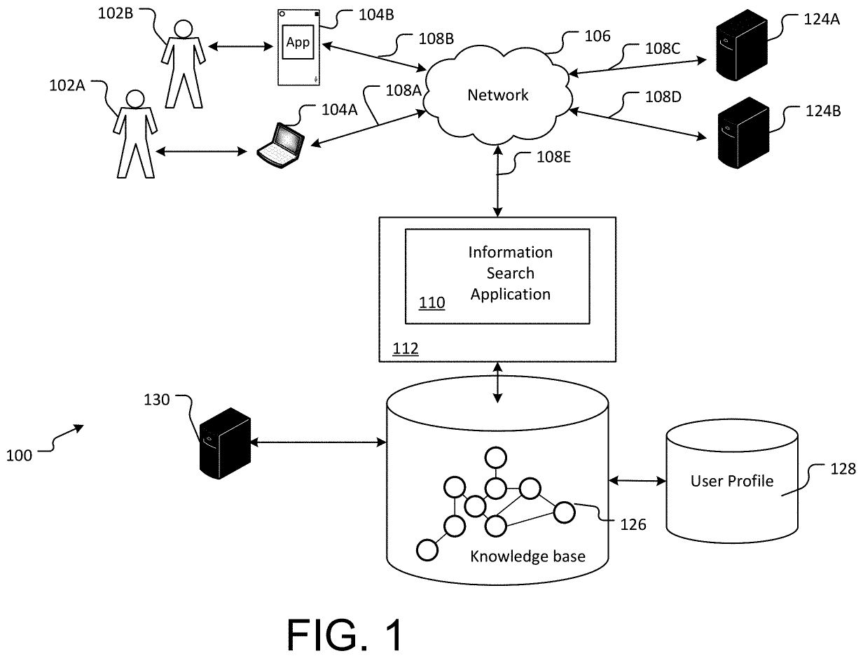

FIG. 1 illustrates an overview of an example system for ranking and post-ranking a search result based on personal affinity.

System 100 may include one or more client computing devices 104 (e.g., client computing devices 104A and 104B) that may execute a client version of an information search application (e.g. a web search service application) capable of optimizing ranking of search results at the global-level and then post-ranking at the user-level using a knowledge base as a personal profile. The knowledge base may include a graph database. In some examples, the information search may execute locally on a client computing device 104. In other examples, an information search application (e.g., a mobile application on a thin client computing device 104) may operate in communication (e.g., via network 106) with a corresponding server version of the information search application 110 executing on one or more server computing devices, e.g., server computing device 112. In still other aspects, rather than executing a client version of an information search application, the one or more client computing devices 104A-B, used respectively by users 102A-B, may remotely access, e.g., via a browser connecting to the network 106 via links 108A-B, the the information search application 110. The information search application 110 may be implemented on the server computing device 130 or multiple server computing devices in a distributed computing environment (under a cloud computing environment, for example.)

As illustrated by FIG. 1, a server version of an information search application 110 is implemented by a server computing device 112. As should be appreciated, the server version of an information search application 110 may also be implemented in a distributed environment (e.g., cloud computing environment) across a plurality of server computing devices (not shown). Moreover, either a client or a server version of the information search application 110 may be capable of receiving a search query from a user, search for information based on the query, generate a ranked list of information as a search result, post-rank the ranked list based on personal affinity of the user to generate a post-ranked list of information as a search result, and provide the list to the user. While a server version of the information search application 110 is shown and described, this should not be understood as limiting. Rather, a client version of the information search application 110 may similarly be implemented on a client computing device 104.

In a basic configuration, the one or more client computing devices 104 may be personal or handheld computers having both input elements and output elements operated by one or more users 102 (e.g., a user 102A and another user 102B). For example, the one or more client computing devices 104 may include one or more of: a mobile telephone; a smart phone; a tablet; a phablet; a smart watch; a wearable computer; a personal computer; a desktop computer; a laptop computer; a gaming device/computer (e.g., Xbox®); a television; and the like. This list is exemplary only and should not be considered as limiting. Any suitable client computing device for executing the information search application 110 may be utilized.

In some aspects, network 106 is a computer network, including but not limited to an enterprise intranet, an enterprise extranet and/or the Internet. In this regard, the network 106 may include a Local Area Network (LAN), a Wide Area Network (WAN), the Internet, wireless and wired transmission mediums. In further aspects, a server computing device 112 and other server computing devices 124A and 124B may communicate with some components of the system via respective links 108A-E to a local network (e.g., an enterprise intranet), whereas the server computing device 112 may communicate with other components of the system via a wide area network (e.g., the Internet). In addition, the aspects and functionalities described herein may operate over distributed systems (e.g., cloud computing systems), where application functionality, memory, data storage and retrieval, and various processing functions may be operated remotely from each other over a distributed computing network, including but not limited to the Internet or an intranet.

As described above, the information search application 110 may be implemented on a server computing device 112. In a basic configuration, server computing device 112 may include at least a processing unit and a system memory for executing computer-readable instructions. In some aspects, server computing device 112 may comprise one or more server computing devices 112 in a distributed environment (e.g., cloud computing environment). The server computing device 112 may generate, store and/or access user activity logs (and any associated content, attributes or properties) stored in a knowledge base 126 and determine personal affinity to a particular category of the user. The user activity logs (and any associated content, attributes or properties) may also be generated, stored and/or accessed in the knowledge base 126 by the one or more client computing devices 104 and/or one or more other server computing devices (e.g., server computing devices 124A and/or 124B) via network 106. In some aspects, the knowledge base 126 may comprise a graph database and may be managed or maintained by one or more other server computing devices 130, which may include at least a processing unit and system memory (including cache memory) for executing computer-readable instructions.

The information search application 110 may include one or more components for generating a search result based on an input query and ranking and post-ranking the search result. In aspects the components may communicate and pass data between the other components. The various components may be implemented using hardware, software, or a combination of hardware and software. Moreover, the various components may be executed on a single server computing device (e.g., server computing device 112), on multiple server computing devices (e.g., server computing devices 112, 124A, 124B, and 130), or locally on one or more client computing device (e.g., client computing devices 104A and/or 104B).

A knowledge base 126 may contain information about users accessing and using the information search application 110. For example, the knowledge base 126 may include history logs of search terms from query inputs as received by the information search application 110 from the users 102 (102A and 102B) and search results. In some aspects the knowledge base 126 may be implemented as a graph database with one or more graphs to which the query inputs and/or the search results may be stored by ingesting entities and relations as extracted from the query inputs and/or the search results. The information in the knowledge base 126 may be used to determine personal affinities of respective users traversing the graphs.

A user profile 128 may store profile information for users. The profile information may include but not limited to the login information of the respective users as well as a personal affinity of the respective users to particular categories of interests. For example, the user profile 128 may store a personal affinity of some user as technical while storing another personal affinity, business, for some other users. The personal affinity as stored in the user profile 128 may be determined based on a knowledge base 126.

As should be appreciated, the various methods, devices, components, etc., described with respect to FIG. 1 is not intended to limit the system 100 to being performed by the particular components described. Accordingly, additional topology configurations may be used to practice the methods and systems herein and/or components described may be excluded without departing from the methods and systems disclosed herein.

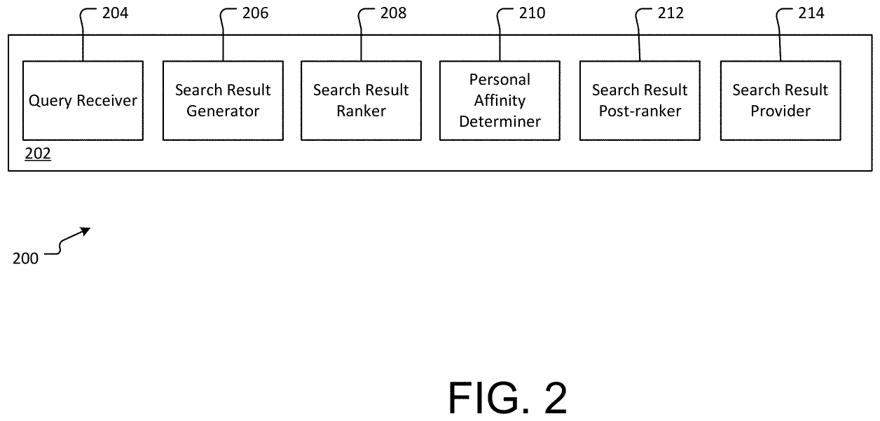

FIG. 2 illustrates an exemplary component diagram of an information search system. In some aspect components of the information search application 200 may be implement on a sever 202. The information search application 200 may include a query receiver 204, a search result generator 206, a search result ranker 208, a personal affinity determiner 210, a search result post-ranker 212, and a search result provider 122142.

A query receiver 204 may receive a query input from the user or an entity that requests a search for information. A search result generator 206 may generate a search result by searching for information that are pertinent to the query input on servers with information. For example, a scope of the search may span across the Internet, private networks and local storages. The information may be located in the server devices 112, 124A, 124B, and 130. In some aspects, the query receiver 204 may receive a query input from a computing device (e.g., one or more client computing devices and/or one or more serving computing devices) via the network 106. The query may comprise terms to be used to search for information. In some aspects, the query receiver 204 may receive the query from a user 102A and/or 102B using computing devices 104A and/or 104B respectively and extract entities from the query using machine language technologies and generate terms for searching for information.

A search result generator 206 may generate a search result as a form of a list of information. In some aspect, the search result generate 206 generates a search result in a form of a list of information based on the global optimization functions.

A search result ranker 208 may rank the list of information as a search result based on the global optimization functions. In some aspects, the search result ranker 208 may rank individual information based on relevance scores assigned to the individual information. The relevance scores may be determined as confidence scores that indicates how closely each of the information matches the received query input. The confidence scores may be based on the global optimization functions. In compiling the ranking list, information with higher relevance scores may be ranked higher than other information. In some aspects, an output of the search result ranker may be a list of information that are ranked according to the global optimization functions.

Examples of the global optimization functions may include accurately interpreting the input query, efficiently searching through a vast amount of information stored at web sites over the Internet and by applying machine language algorithms to globally rank the top documents from the Internet. The global optimization may also take into account locations, overall context of geographically and culturally-specific markets and languages, and a super-fresh content that is the most recent information. For example, the latest-developing news available on the Internet may be the most recent information.

A personal affinity determiner 210 may determine a personal affinity to one or more categories that match with the user who have provided the query input. The personal affinity determiner 210 may determine the affinity to categories by analyzing search history logs and looking up a user profile. For example, the personal category determiner 210 may determine a personal affinity of a user “Alice” to be a category “Technology” by analyzing Alice's usage log to conclude that Alice tends to search for technical information. A user profile of Alice may indicate that Alice is in a technical occupation, a software engineer for example. In some aspect, an output from the personal category determiner 210 may include a type or personal affinity of the user as “Technology,” for example. Based on statistical data, policies, system characteristics and/or other heuristics, a ranking of information with respect to relevance to the query input maybe generated. The personal affinity may describe one or more particular areas of interests or preferences of the user, as the user may regard the information in the category as being more important than information in other areas. In some aspects, the personal affinity determiner 210 may determine a personal affinity based on a knowledge base that collects, stores, and organizes query search terms and user operations as a usage history of the user. In some other example, the personal affinity determiner 220 may extract entities from the query search terms and store entities in the knowledge base. Moreover, the knowledge base may store additional information about the user and categorize the information into one or more categories that indicate a personal affinity of the user.

As described above, records in a graph database may comprise nodes and at least one edge and properties that are associated with the nodes and the at least one edge. In some aspects, the graph database may be implemented based on a Resource Description Framework. While not shown in figures, a node may describe a subject, an object, or both. An edge may describe a predicate. For example, there may be a node that is a subject with a value “Alice,” another node with a value “CSS” as an object with a link from the former to the latter nodes with a predicate value “searches.” Further, there may be another node that is an object with a value “Technical” with a link from “CSS” to “Technical” with a predicate “is under category of” Traversing from the node “Alice” to “CSS,” and then to “Technical” by following the links, the personal affinity determiner 118 may determine that Alice as a user has a personal affinity to a category of “Technical.”

A search result post-ranker 212 may post-rank (or re-rank) the ranked information based on the personal affinity as determined by the personal category determiner 210. In some aspects, the search result post-ranker 212 may post-rank the ranked list of information by re-ranking the ranked list based on the personal affinity. The re-ranking may be performed while retaining the overall ranking of the information as ranked by the search result ranker 208 based on the global optimization functions. For example, the search result post-ranker 212 may partition the ranked list into multiple portions based on confidence scores as assigned to each of information on the ranked list. Suppose in a system that provides a search result by displaying nine entries of information as a search result on a page. In some aspects, the search result post-ranker 212 may separate the list into three portions, each of which containing three entries of information (e.g., the top three highest relevant entries of the information in a first portion, the next three highest relevant entries of the information in a second portion, and the last three highest relevant entries of the information in a third portion. The search result post-ranker 212 may re-rank entries of the information within respective portions without moving entries across the portions. This way, the most significant re-ranking of an entry would be to boost or to lower ranking by two ranks (e.g., the third place entry may be moved to the first place entry) according to a personal affinity at user level, while retaining the overall ranking based on the global optimization functions. In some aspect, the search result post-ranker 212 may post-rank the list of information when at least one of the following conditions are satisfied. In some other aspect, the search result post-ranker 212 may post-rank the list of information when all of the following conditions are satisfied:

1) the user is logged onto the system, enabling to identify user-specific information, the personal affinity for example, to a category by referring to the user management table; for example, the user may be able to log in through a browser software running on the client computing device; 2) a personal affinity of the user is determined; 3) a category based on the intent of the query input matches with the personal affinity; and 4) the ranked list of information contains a number of entries of information that matches with the category and the personal affinity greater than a predefined threshold or a specific condition.

A search result provider 214 may provide a search result to the user. For example, the search result provider 214 may provide the list of post-ranked information as post-ranked by the search result post-ranker 212 by transmitting the list data to the user, to a client device for example. If the above mentioned one or more specific conditions for post-ranking are not satisfied, the search result provider 214 may provide the ranked list of information without post-ranking.

In some other aspects, one or more components of the information search system 200 may be implemented on the server 202 while other components are implemented in a user-specific computing device, a client computing device for example (not shown in FIG. 2). For example, the query receiver 204, the personal result post-ranker 212, and the search result post-ranker 212, and the search result provider 214 may be implemented on the client computing device, while the search result generator 206 and the search result ranker 208 may be implemented on the server 202. In some aspects, the search result provider 122 may provide the ranked list of information without post-ranking the list when a predetermined condition for post-ranking is not satisfied and the post-ranking does not take place. In some other aspects, the search result provider 122 may provide both the ranked list of information and the re-ranked list of information to the user to enable the user to read both the ranked information based on the global optimization functions and the post-ranked information based on the user-level optimization based on the personal affinity.

As should be appreciated, the various methods, devices, components, etc., described with respect to FIG. 2 is not intended to limit example of the information search system 200. Accordingly, additional topology configurations may be used to practice the methods and systems herein and/or components described may be excluded without departing from the methods and systems disclosed herein.

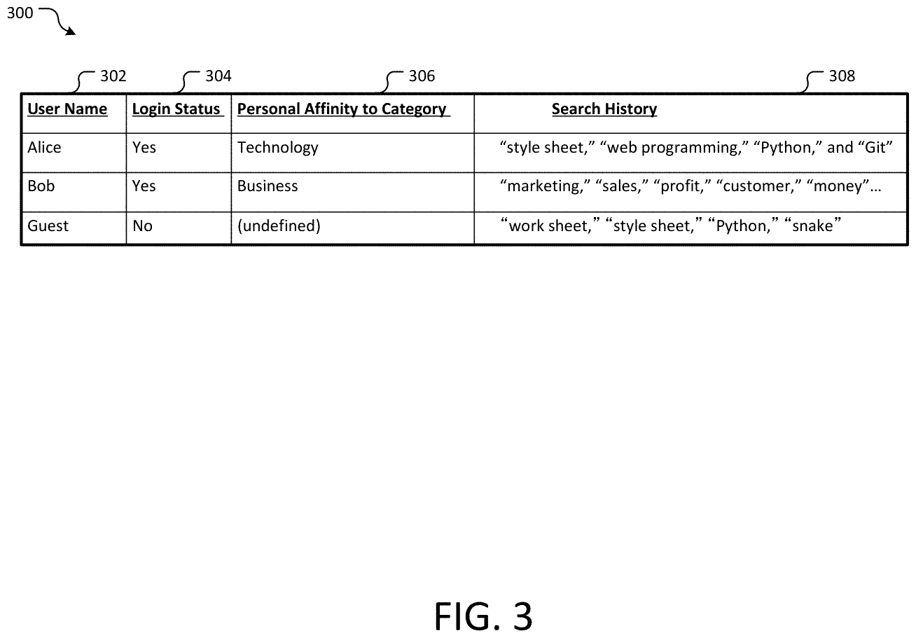

FIG. 3 illustrates an example of a user management table. The user management table may contain various columns including but not limited to a user name 302, a login status 304, a personal affinity to a category 306, and a search history data 308. In some aspects, the user profile 128 may include the user management table 300.

In some aspect, the personal affinity determiner may read the user management table to check whether the user is logged into the system. FIG. 3 shows that a user Alice is logged in (with Login Status set as “Yes,” and the personal affinity to a category “Technology.” The user management table may contain or refer to search histories of respective users under Search History 308. For Alice, the search history includes use of words “style sheet,” “web programming,” “Python,” and “Git,” for example. Based on the search history data, the system may determine “Technology” as Alice's personal affinity because all of these terms are associated with technologies that relates to technologies on developing websites. For the case of another user “Bob,” the terms “marketing,” “sales,” “profit,” “customer,” and “money,” for example, enable the system to infer that Bob's personal affinity is in the category of “Business” because these terms relate to businesses more than technologies. A user “Guest” may indicate situations when the user does not login or login as a guest to the system to provide query inputs. For the Guest user, the user management table 300 may indicate, for example, personal affinity as undefined. For the cases with undefined personal affinity, the search result provider may provide a list of information that is ranked based on the global optimization functions only, without user-level optimizations. In some aspects, the system may maintain a list of predefined personal affinities. In some other aspects, the users may be prompted by the system through the user interface for the users to select or input one or more categories of interests as personal affinity.

As should be appreciated, the various methods, devices, components, etc., described with respect to FIG. 3 is not intended to limit example of the user management table 300. Accordingly, additional topology configurations may be used to practice the methods and systems herein and/or components described may be excluded without departing from the methods and systems disclosed herein.

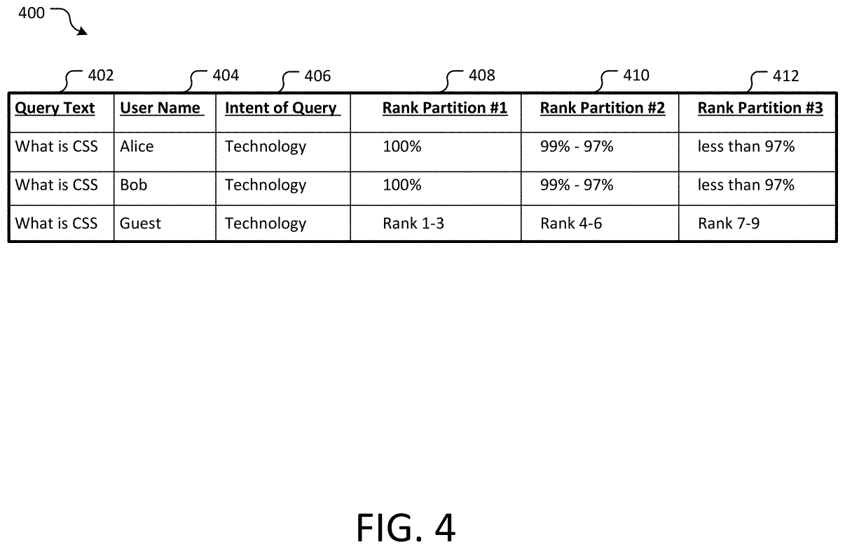

FIG. 4 illustrates an example of a data structure 400 for a query table according to an example system. The data structure 400 of the query table may include a list of queries as input by the users. Each query entry data may include a query text 402, a user name 404, an intent of query 406, a rank portion #1 408, a rank portion #2 410, and a rank portion #3 412. In some aspects, the knowledge base 126 may store the query table by converting the data structure 400 into entities and nodes of a graph.

For example, the data structure 400 illustrates a situation where there are three instances of receiving query inputs “What is CS S,” each time by a different user Alice, Bob, and a guest as shown under the user name 404. The intent of query 406 may indicate an area and/or a category of the intent of each query. The exemplar data structure 400 shows that the queries have the same intent value “Technology.” In some other aspects, different values may be set for respective queries. In some aspect, the example system determines and sets a value for an intent of a query by parsing a query input, identifying entities in the query input, and classifying respective entries based on technologies including but not limited to machine learning, rule-based decision trees, and statistical analyses into a value. In some other aspects, the example system may use knowledge trees based on graph databases to determine the intent by traversing the graph databases. In aspects, the example system may determine an intent of a query input independent of a personal affinity to a particular category by the user who has input the query. In some other aspects, the example system may determine the intent of the query input with taking into account the personal affinity by looking up a data structure the user management table 300 as described above as an example.

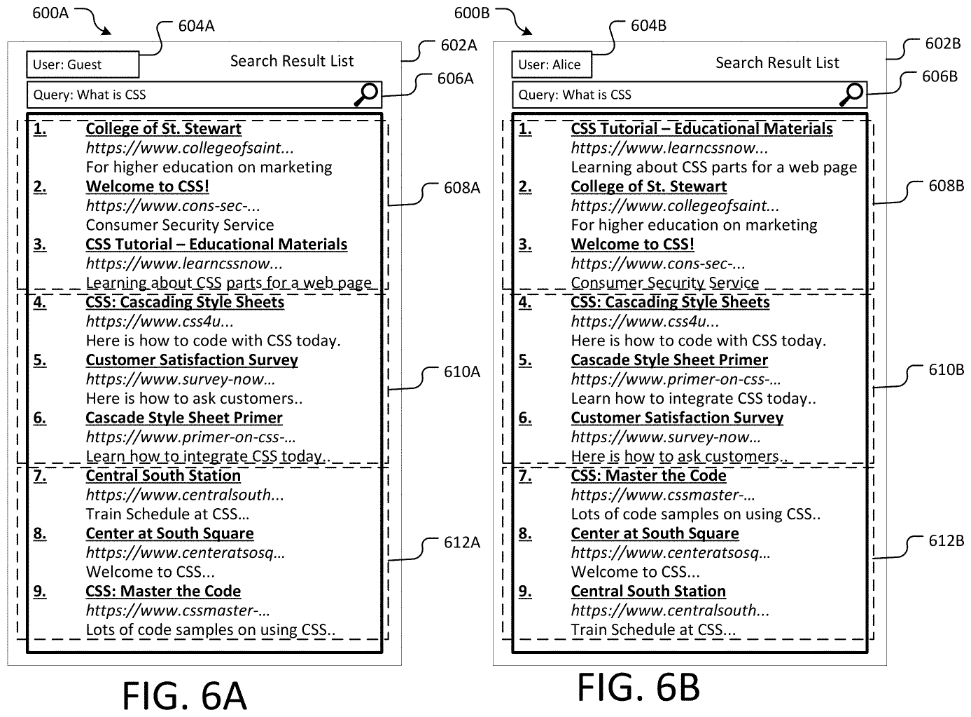

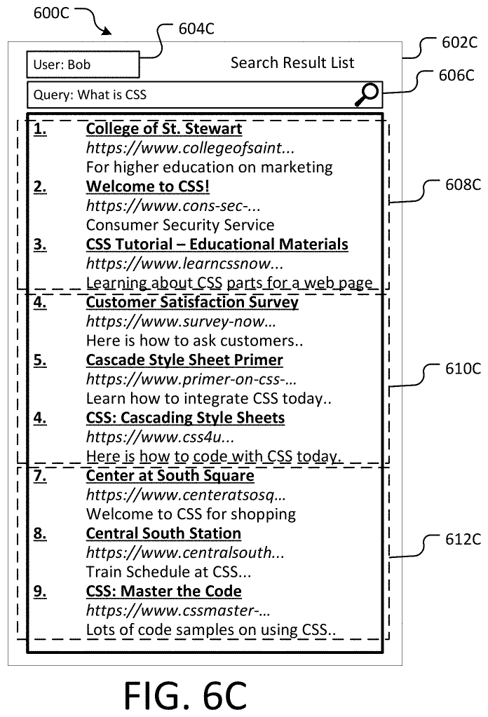

The rank portion #1 408, the rank portion #2 410, and the rank portion #3 412 may indicate which entries if a ranked list of information as a search result the respective portions include in providing a search result to the respective users. For example as shown in the first row of data in the data structure 400, Alice has entered a query test “What is CSS.” In rendering a list of ranked entries of information as a search result, the data structure 400 indicates that the rank portion #1 408 includes entries with a match level (or a confidence level, e.g., a likelihood that an entry matches with the query input) at 100% in the portion #1. The rank portion #2 410 includes entries with the matching level 99%-95% in the partition #2; the rank portion #3 includes entries with the matching level at less than 95% in the partition #3. In contrary, as guest enters a query input “What is CSS,” the rank portion #1 408 includes the first three entries of the ranked list of information as a search result. The rank portion #2 410 includes fourth, fifth, and sixth ranked entries. The rank portion #3 412 specifies sixth, seventh, and ninth entry of information as a search result in the rank portion #3. In some aspects, the entries as specified by the rank portion #1 may be displayed at the top portion of a search result page, while those in the ranked partition #2 may be displayed in the middle section, and the ranked partition #3 may be displayed in the lower section of the search result page. See also, FIGS. 6A-C.

As should be appreciated, the various methods, devices, components, etc., described with respect to FIG. 4 is not intended to limit example of the user management table 400. Accordingly, additional topology configurations may be used to practice the methods and systems herein and/or components described may be excluded without departing from the methods and systems disclosed herein.

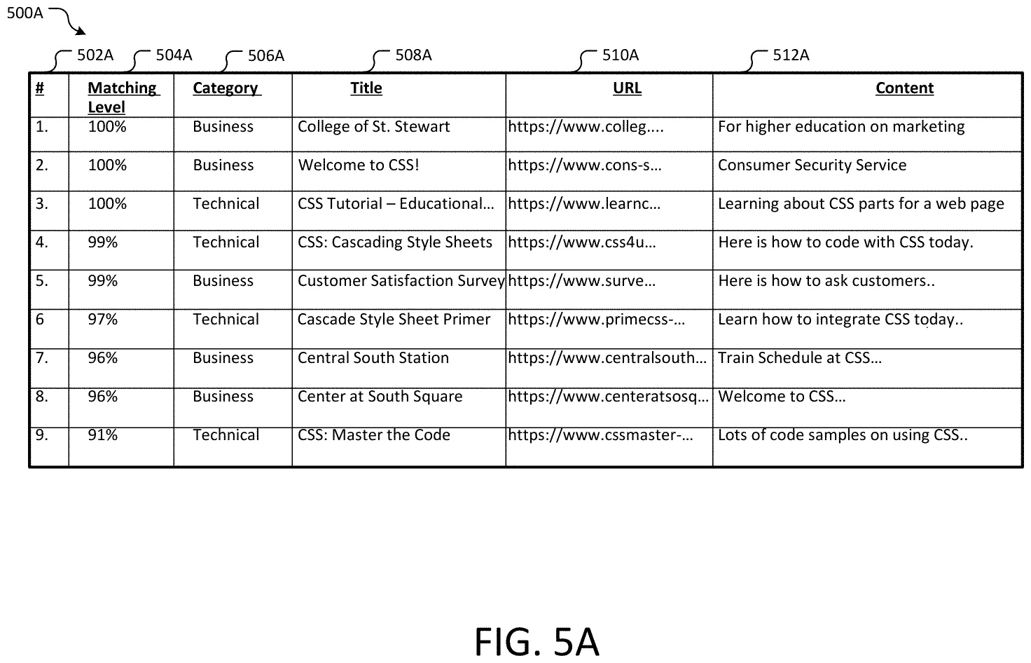

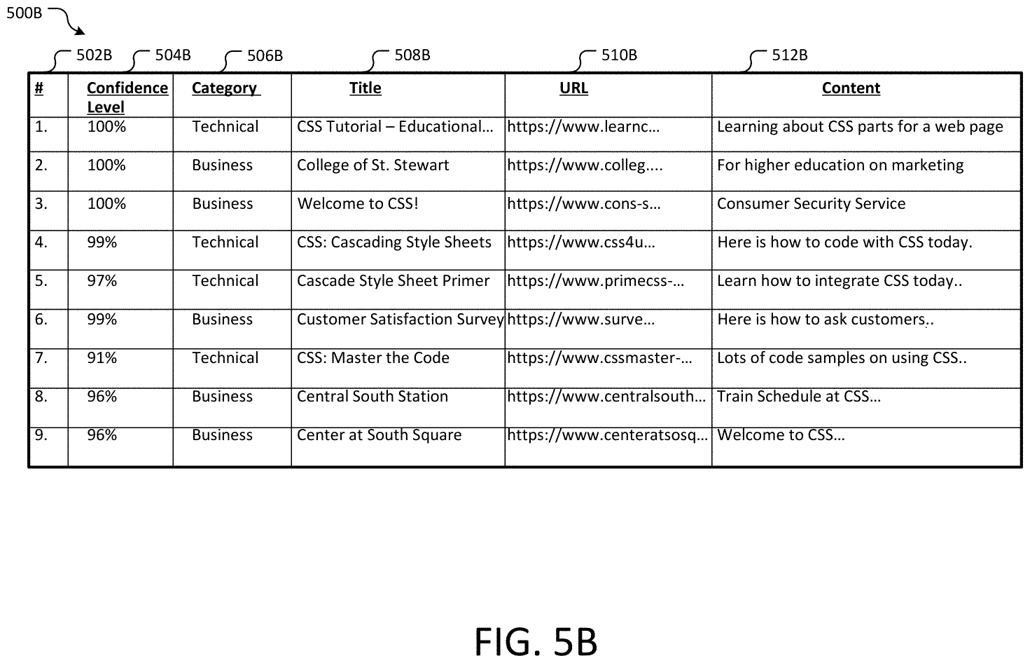

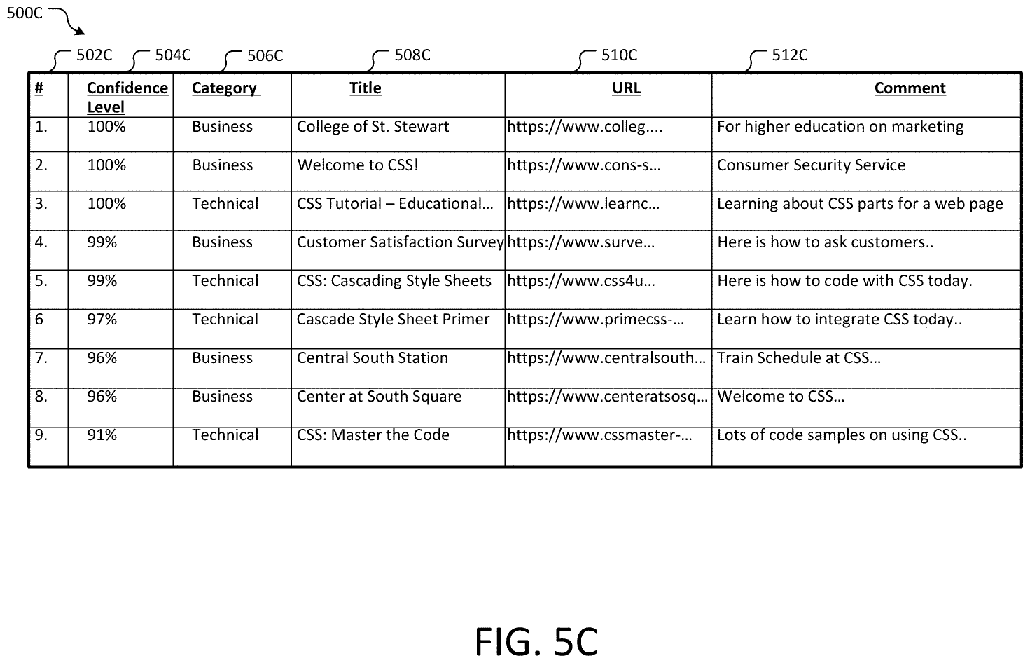

FIGS. 5A-C illustrate an example of data structures 500A-C for search result tables. In particular, the data structures describe ranked lists of entries of information for different users or different personal affinities.

FIG. 5A illustrates a data structure 500A of the search result based on the global optimization functions. In some aspects, the search result ranker 208 as shown in FIG. 2 may output the data structure 500A. The data structure 500A may include a ranked list of information as a search result. The exemplar search result includes nine entries of information based on a query input “What is CSS.” For each entry, the data structure 500A indicates a ranking number #502A, a matching level 504A, a category of the information as an entry 506A, a title of the information 508A, an URL specifying a location to retrieve the information 510A, and a content 512A of the information.

The top ranked entry of information as a search result as conveyed in the data structure 500A has a matching level 100%, having a category of “Business,” “College of St. Stewart” as its title, “https://www.colleg . . . ” as its URL (Universal Resource Locator), and “For higher education on marketing” as content or at least a part of the content or a comment of the information. The matching level 504A indicates how closely the entry of information matches with the query input. For example, the matching level may be at 100% when the search result ranker 208 ranks the information with the highest level of confidence based on analysis to match the information and the query input. The fourth ranked entry in the data structure 500A is an entry with a matching level 99%, a category “Technical,” with a title “CSS: Cascading Style Sheets” at URL “https://www.css4u . . . ” and a content “Here is how to code with CSS today.”

In some aspects, the search result provider may provide a list of entries for information as a search result based on the data structure 500A when the search result is based on the global optimization functions as ranked by the search result ranker. The data structure 500A may be used as the base ranked list for the search result post-ranker to re-rank the ranked list based on the user-level optimization including a personal affinity of the user.

FIG. 5B illustrates a data structure 500B of the search result based on the global optimization functions. In some aspects, the search result post-ranker 212 as shown in FIG. 2 may output the data structure 500B based on Alice (with the personal affinity “Technical”) as the user who input the query. The data structure 500B may include a ranked list of information as a search result. The exemplar search result includes nine entries of information based on a query input “What is CSS.” For each entry, the data structure 500B indicates a ranking number #502B, a matching level 504B, a category of the information as an entry 506B, a title of the information 508B, an URL specifying a location to retrieve the information 510B, and a content 512B of the information.

For example, the top ranked entry of information as a search result as conveyed in the data structure 500B has a matching level 100%, having a category of “Technical,” with “CSS Tutorial—Education . . . ” as its title, “https://www.learnc . . . ” as its URL (Universal Resource Locator), and “Learning about CSS parts for a web page” as content or at least a part of the content or a comment of the information. The matching level 504B indicates how closely the entry of information matches with the query input. For example, the matching level may be at 100% when the search result post-ranker 212 re-ranks the information with the highest level of confidence based on analysis to match the information and the query input. The fourth ranked entry in the data structure 500B is an entry with a matching level 99%, a category “Technical,” with a title “CSS: Cascading Style Sheets” at URL “https://www.css4u . . . ” and a content “Here is how to code with CSS today.”

In some aspect, the search result post-ranker 212 may re-rank the ranked list as ranked by the search result ranker 208 based on a personal affinity of the user who has provided the query input. For example, the search result post-ranker 212 may look up a user profile of the user Alice from the data structure 300, and re-rank the ranked list as shown in FIG. 5A to generate the data structure 500B based on a personal affinity of Alice, which is “Technology.”

The search result post-ranker 212 may further look up the data structure 400 and re-rank the ranked list by moving entries within respective rank portions. Those entries with a category that matches with the personal affinity are ranked higher than those entries without the category in the same rank portions. Accordingly, for the example using the data structure 500B, compares entries that are within the same respective rank portions. For the rank portion #1, the top three entries with the matching level 100% are compared. The third ranked entry has the category of “Technical” that matches with the personal affinity of Alice. The other two has the category of “Business.” Accordingly, the search result post-ranker 212 moves the entry that is ranked at third by the search result ranker 208 as shown in FIG. 5A to the first rank as shown in FIG. 5B.

Similarly, as shown in FIG. 5B, the search result post-ranker 212 re-ranks the entry that is ranked at sixth in the data structure 500A in FIG. 5A to fifth rank in the data structure 500B in FIG. 5B. Moreover, the search result post-ranker 212 re-ranks the entry that is ranked at ninth in the data structure 500A in FIG. 5A to seventh in the data structure 500B in FIG. 5B.

FIG. 5C illustrates a data structure 500C of the search result based on the global optimization functions. In some aspects, the search result post-ranker 212 as shown in FIG. 2 may output the data structure 500C based on Bob (with the personal affinity “Business”) as the user who input the query. The data structure 500C may include a ranked list of information as a search result. The exemplar search result includes nine entries of information based on a query input “What is CSS.” For each entry, the data structure 500C indicates a ranking number #502C, a matching level 504C, a category of the information as an entry 506C, a title of the information 508C, an URL specifying a location to retrieve the information 510C, and a content 512C of the information.

For example, the top ranked entry of information as a search result as conveyed in the data structure 500C has a matching level 100%, having a category of “Business,” with “College of St. Stewart” as its title, “https://www.colleg . . . ” as its URL (Universal Resource Locator), and “For higher education on marketing” as content or at least a part of the content or a comment of the information. The matching level 504C indicates how closely the entry of information matches with the query input. For example, the matching level may be at 100% when the search result post-ranker 212 re-ranks the information with the highest level of confidence based on analysis to match the information and the query input. The fourth ranked entry in the data structure 500C is an entry with a matching level 99%, a category “Business,” with a title “Customer Satisfaction Survey” at URL “https://www.surve . . . ” and a content “Here is how to ask customers . . . ”

In some aspect, the search result post-ranker 212 may re-rank the ranked list as ranked by the search result ranker 208 based on a personal affinity of the user who has provided the query input. For example, the search result post-ranker 212 may look up a user profile of the user Bob from the data structure 300, and re-rank the ranked list as shown in FIG. 5A to generate the data structure 500B based on a personal affinity of Bob, which is “Business.”

The search result post-ranker 212 may further look up the data structure 400 and re-rank the ranked list by moving entries, within respective rank portions. Those entries with a category that matches with the personal affinity may be ranked higher than those entries without the category in the same rank portions. Accordingly, for the example using the data structure 500C, compares entries that are within the same respective rank portions. For the rank portion #1, the top three entries with the matching level 100% are compared. The third ranked entry has the category of “Technical” that fails to match the personal affinity of Bob. The other two has the category of “Business.” Accordingly, the search result post-ranker 212 maintains the ranking of the entries in the rank portion #1. That is, the ranking of information within the rank portion #1 remains the same between the data structure 500A in FIG. 5A and 500C in FIG. 5C.

However, as shown in FIG. 5C, the search result post-ranker 212 re-ranks the entry that is ranked at fifth in the data structure 500A in FIG. 5A to fourth rank in the data structure 500C in FIG. 5C. The change in the rankings may be limited within the rank portion #2. This way, the ranking based on the global optimization functions may be maintained at the level of rank portions while rankings within respective rank portions may be post-ranked based on the personal affinity.

As should be appreciated, the various methods, devices, components, etc., described with respect to FIGS. 5A, 5B, and 5C are not intended to limit example of the data structures for the search results 500A-500C. Accordingly, additional topology configurations may be used to practice the methods and systems herein and/or components described may be excluded without departing from the methods and systems disclosed herein.

FIGS. 6A, 6B, and 6C illustrate examples of a user interface (GUI) for receiving query inputs and displaying ranked lists of information as search results.

FIG. 6A illustrates an example GUI 600A for receiving a query input 606A and providing a ranked list of information as a search result in respective rank portions (608A, 610A, and 612C) when the user is a guest user. A window 602A includes various user interface sections to constitute the example GUI 600A. The search result as shown in FIG. 6A corresponds to a set of search result that the search result ranker 208 output based on the global optimization functions. The ranked list of information in FIG. 6A corresponds to the data structure 500A in FIG. 5A.

A user section 604A indicates a user “Guest” as a user who uses the GUI to input a query for search. A query section 606A indicates a query input “What is CSS.” In some aspects, the user may input query by entering a text string. In some other aspects, the user may speak a query and the system may recognize the query through voice recognition technologies and display the query in text. In some aspects, the GUI receives a user input. For example, the GUI may receive a click on the lens icon with a mouse or a press key event on the Enter key for the query receiver, shown as a query receiver 204 as an example, to receive the query input.

A rank portion #1 608A indicates a set of three entries within the rank portion #1. In particular, the rank portion #1 608A includes entries of information at ranks 1-3 based on the data structure 500A of FIG. 5A: “#1 College of St. Stewart,” “#2 Welcome to CSS!,” and “#3 CSS Tutorial—Educational Materials”. In some aspects, the data structure 400 for a query list may specify conditions of selecting information for the rank portion #1 608A to be at the top three ranks when a user is Guest.

A rank portion #2 610A indicates a set of three entries (ranks #4, #5, and #6) within the rank portion #2. In particular, the rank portion #2 610A includes entries of information at ranks fourth through sixth as specified by the data structure 400 of the query list for Guest, based on the data structure 500A of FIG. 5A.

A rank portion #3 612A indicates a set of three entries (ranks #7, #8, and #9) within the rank portion #3. In particular, the rank portion #3 612A includes entries of information at ranks seventh through ninth as specified by the data structure 400 of the query list for Guest, based on the data structure 500A of FIG. 5A.

FIG. 6B illustrates an example GUI 600B for receiving a query input 606B and providing a ranked list of information as a search result in respective rank portions (608B, 610B, and 612B) when the user is Alice. A window 602B includes various user interface sections to constitute the example GUI 600B. The search result as shown in FIG. 6B corresponds to a set of search result that the search result post-ranker 212 outputs by re-ranking the ranked list based on the personal affinity of Alice. The ranked list of information in FIG. 6B corresponds to the data structure 500B in FIG. 5B.

A user section 604B indicates a user “Alice” as a user who uses the GUI to input a query for search. A query section 606B indicates a query input “What is CSS.” In some aspects, the user may input query by entering a text string. In some other aspects, the user may speak a query and the system may recognize the query through voice recognition technologies and display the query in text. In some aspects, the GUI receives a user input when the user clicks the lens icon with a mouse or a press key event on the Enter key. Based on the user input, the query receiver, a query receiver 204 for example, to receive the query input.

A rank portion #1 608B indicates a set of three entries within the rank portion #1. In particular, the rank portion #1 608B includes entries of information with the matching level at 100% based on the data structure 500B of FIG. 5B: #1 CSS Tutorial—Educational Materials; #2 College of St. Stewart, and #3 Welcome to CSS!. In some aspects, the data structure 400 for a query list may specify conditions of selecting information for the rank portion #1 608B to be information with the matching level 100% when a user is Alice with the query input of “What is CSS.”

A rank portion #2 610B indicates a set of three entries (ranks #4, #5, and #6) listed within the rank portion #2. In particular, the rank portion #2 610B includes entries of information with the matching level 99%-97% as specified by the data structure 400 of the query list for Alice, based on the data structure 500B of FIG. 5B.

A rank portion #3 612B indicates a set of three entries (ranks #7, #8, and #9) within the rank portion #3. In particular, the rank portion #3 612B includes entries of information with the matching level that is less than 97% as specified by the data structure 400 of the query list for Alice, based on the data structure 500B of FIG. 5B.

FIG. 6C illustrates an example GUI 600C for receiving a query input 606C and providing a ranked list of information as a search result in respective rank portions (608C, 610C, and 612C) when the user is Bob. A window 602C includes various user interface sections to constitute the example GUI 600C. The search result as shown in FIG. 6C corresponds to a set of search result that the search result post-ranker 212 outputs by re-ranking the ranked list based on the personal affinity of Bob. The ranked list of information in FIG. 6C corresponds to the data structure 500C in FIG. 5C.

A user section 604C indicates a user “Bob” as a user who uses the GUI to input a query for search. A query section 606C indicates a query input “What is CSS.” In some aspects, the user may input query by entering a text string. In some other aspects, the user may speak a query and the system may recognize the query through voice recognition technologies and display the query in text. In some aspects, the GUI receives a user input when the user clicks the lens icon with a mouse or a press key event on the Enter key. Based on the user input, the query receiver, a query receiver 204 for example, to receive the query input.

A rank portion #1 608C indicates a set of three entries within the rank portion #1. In particular, the rank portion #1 608C includes entries of information with the matching level at 100% based on the data structure 500C of FIG. 5C: #1 College of St. Stewart, #2 Welcome to CSS!, and #3 CSS Tutorial—Educational Materials. In some aspects, the data structure 400 for a query list may specify conditions of selecting information for the rank portion #1 608B to be information with the matching level 100% when a user is Bob with the query input of “What is CS S.”

A rank portion #2 610C indicates a set of three entries (ranks #4, #5, and #6) listed within the rank portion #2. In particular, the rank portion #2 610C includes entries of information with the matching level 99%-95% as specified by the data structure 400 of the query list for Alice, based on the data structure 500C of FIG. 5C.

A rank portion #3 612C indicates a set of three entries (ranks #7, #8, and #9) within the rank portion #3. In particular, the rank portion #3 612C includes entries of information with the matching level that is less than 97% as specified by the data structure 400 of the query list for Alice, based on the data structure 500C of FIG. 5C.

As should be appreciated, the various methods, devices, components, etc., described with respect to FIGS. 6A, 6B, and 6C are not intended to limit GUIs 600A, 600B, and 600C. Accordingly, additional topology configurations may be used to practice the methods and systems herein and/or components described may be excluded without departing from the methods and systems disclosed herein.

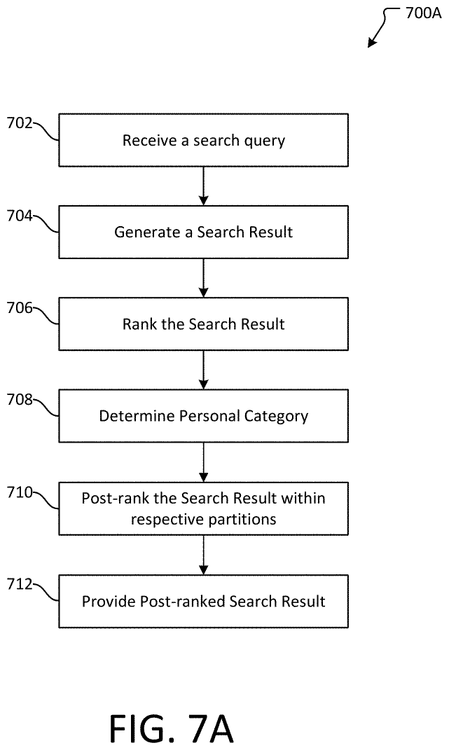

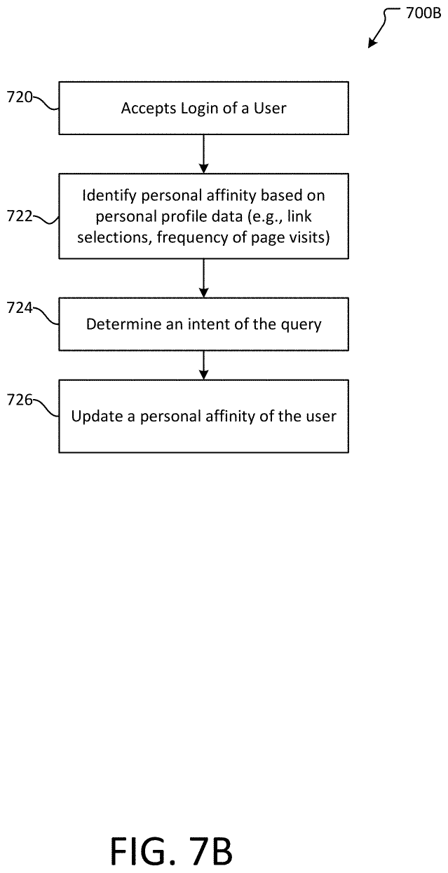

FIGS. 7A-7B illustrate examples of steps of processing a search query according to an example system with which the disclosure may be practiced.

FIG. 7A illustrates an example method 700A of ranking and post-ranking information to provide a search result. A receive operation 702, by the query receiver 204 of the information search application 200 as implemented on the server 202 for example, receives a search query as a query input data. In some aspects, the receive operation 702 may be implemented on a client computing device as exemplified by the computing devices 104A and/or 104B respectively used by the user 102A and/or 102B. In some other aspects, the receive operation 702 may store the query input data in the knowledge base 126 as a history log of search terms. The history log of search terms in the knowledge base 126, which includes search terms previously received from respective users, may be used to determine a personal affinity of respective users. A generate operation 704, by the search result generator 206 for example, generates a search result based on the query input. In some aspects, the generate operation 704 may include searching for information that matches with the query input at various information storages and information service providers over the network. A rank operation 706, by the search result ranker 208 for example, ranks the search result. In some aspects, the rank operation 706 may rank the search result based on the global optimization functions.

Examples of the global optimization functions may include accurately interpreting the input query, efficiently searching through a vast amount of information stored at web sites over the Internet, and/or by applying machine language algorithms to globally rank the top documents from the Internet. The global optimization may also take into account locations, overall context of geographically and culturally-specific markets and languages, and a super-fresh content that is the most recent information. For example, the latest-developing news available on the Internet may be the most recent information.

A determine operation 708, the personal affinity determiner 210 for example, determines a personal category (or a personal affinity to a category) of the user. In some aspects, the determine operation 708 may determine a personal affinity to one or more categories that match with the user who have provided the query input. The determine operation 708 may determine the personal affinity by analyzing search history logs and looking up a user profile in the user profile 128 and the knowledge base 126 as shown in FIG. 1. The knowledge base may be implemented as a graph database. For example, the determine operation 708 may determine a personal affinity of a user “Alice” to be a category “Technology” by analyzing Alice's usage log as implemented as a graph database to traverse and conclude that Alice tends to search for technical information. While not shown in figures, a user profile of Alice may indicate that Alice is in a technical occupation, a software engineer for example.

A post-rank operation 710, by the search result post-ranker 212 for example, post-ranks (or re-ranks) the search result within respective rank portions based on the personal affinity of the user. In some aspects, the post-rank operation 710 may be performed while retaining, at the level of respective rank portions, the ranking of the information as ranked by the ranking operation 706 based on the global optimization functions.

In some aspect, the post-rank operation 710 may post-rank the list of information when at least one of the following conditions are satisfied. In some other aspect, the search result post-ranker 212 may post-rank the list of information when all of the following conditions are satisfied:
1) the user is logged onto the system, enabling to identify user-specific information by referring to the user management table 300 which may be stored in the user profile 128; the user-specific information may be the personal affinity to a category; the user may be able to log in through a browser software running on the client computing device;
2) a personal affinity of the user is determined;
3) a category based on the intent of the query input matches with the personal affinity; and
4) a ranked list of information contains a number of entries of information that matches with the category and the personal affinity greater than a predefined threshold or a specific condition.

A provide operation 712, by the search result provider 214 for example, may provide the post-ranked search result. The provide operation 712 may include but not limited to transmitting the search result, to displaying the search result, and outputting the search result to the user. In some aspects, the provide operation 712 may include but not limited to displaying the search result on a browser application to the user 102A and/or 102B using computing devices 104A and/or 104B respectively. The post-ranked search result may depend on users, as provided in the user interfaces in FIGS. 6A, 6B, and 6C. Different users may have different personal affinity. For example, the Guest user may have no predefined personal affinity, Alice may be “Technical,” and Bob may be “Business.”

FIG. 7B illustrates an example method 700B of determining a personal affinity to a category. An accept operation 700B accepts login of a user. The accept operation 700B may be implemented by a login application (not shown). In some aspects, the login status of the user may enable to identify the user who provides a query input for search. An identify operation 722, identifies a personal affinity to a category based on user profile 128. In some aspects, the identify operation 722 may be a part of operations by the personal affinity determiner 210. The user profile 128 may include history data that indicate selections of information links by the user. The personal profile data may also include a frequency of the user visiting particular web pages. The user profile 128 may be associated with the knowledge base 126 as shown in FIG. 1.

A determine operation 724, by the search result generator 206 when the determination is based on the global optimization functions, may determine an intent of the query input. An intent of a query input may be determined by analyzing the query input by applying technologies, natural language processing and use of a knowledge base 126 for classification as examples. The determine operation 724 may be implemented as a part of the personal affinity determiner 210 when the determination is based on the user-level optimization functions. In some example, suppose the predetermined threshold is predetermined as at 50%, and the search result shows seven out of a total of ten entries information being classified as Technology. The post-ranking operation based on personal affinity to a category of Technology may be performed because having the seven out of ten entry information is higher than the predetermined threshold of the 50%.

An update operation 726 may update a personal affinity of the user based on the identified personal affinity from the user profile data and the determined intent of the query. In some aspects, the update operation 726 may update values under the personal affinity to category in the data structure 300 of the user management table as shown in FIG. 3. For example, the personal category determiner 210 may perform the update operation 726 to update a personal affinity value of Alice to “Technology” in the data structure 300 in FIG. 3. In some other aspects, the identify operation and 722 and the update operation 726 may be performed off-line without dependency on receiving a query input. The system may continuously accumulate usage history and logs and determine personal affinity of the user.

As should be appreciated, operations 702-716 are described for purposes of illustrating the present methods and systems and are not intended to limit the disclosure to a particular sequence of steps, e.g., steps may be performed in differing order, additional steps may be performed, and disclosed steps may be excluded without departing from the present disclosure.

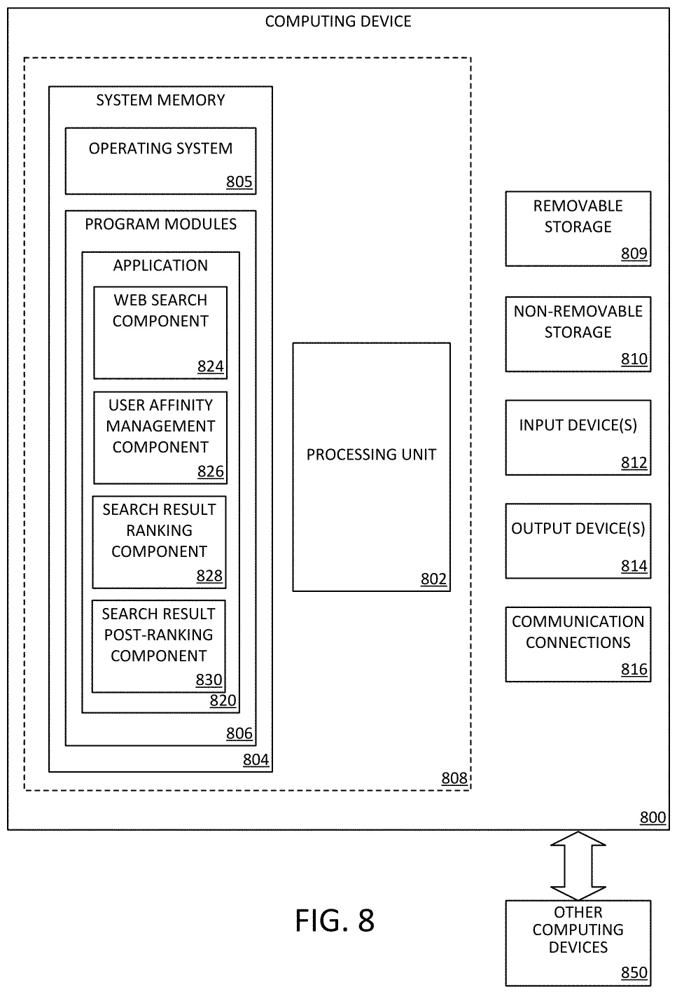

As an example of a processing device operating environment, refer to the exemplary operating environments depicted in FIGS. 8-11. In other example, the components of systems disclosed herein may be distributed across and executable by multiple devices. For example, input may be entered on a client device and information may be processed or accessed from other devices in a network (e.g. server devices, network appliances, other client devices, etc.).

FIGS. 8-11 and the associated descriptions provide a discussion of a variety of operating environments in which aspects of the disclosure may be practiced. However, the devices and systems illustrated and discussed with respect to FIGS. 8-11 are for purposes of example and illustration and are not limiting of a vast number of computing device configurations that may be utilized for practicing aspects of the disclosure, described herein.

FIG. 8 is a block diagram illustrating physical components (e.g., hardware) of a computing device 800 with which aspects of the disclosure may be practiced. The computing device components described below may be suitable for the computing devices described above, including the client computing devices 104A-B and the server computing devices 112 and 124A-B. In a basic configuration, the computing device 800 may include at least one processing unit 802 and a system memory 804. Depending on the configuration and type of computing device, the system memory 804 may comprise, but is not limited to, volatile storage (e.g., random access memory), non-volatile storage (e.g., read-only memory), flash memory, or any combination of such memories. The system memory 804 may include an operating system 805 and one or more program modules 806 suitable for performing the various aspects disclosed herein such as a web search component 824, a user affinity management component 826, a search result ranking component 828 and search result post-ranking component 830. The operating system 805, for example, may be suitable for controlling the operation of the computing device 800. Furthermore, embodiments of the disclosure may be practiced in conjunction with a graphics library, other operating systems, or any other application program and is not limited to any particular application or system. This basic configuration is illustrated in FIG. 8 by those components within a dashed line 808. The computing device 800 may have additional features or functionality. For example, the computing device 800 may also include additional data storage devices (removable and/or non-removable) such as, for example, magnetic disks, optical disks, or tape. Such additional storage is illustrated in FIG. 8 by a removable storage device 809 and a non-removable storage device 810.

As stated above, a number of program modules and data files may be stored in the system memory 804. While executing on the processing unit 802, the program modules 806 (e.g., application 820) may perform processes including, but not limited to, the aspects, as described herein. Other program modules that may be used in accordance with aspects of the present disclosure may include electronic mail and contacts applications, word processing applications, spreadsheet applications, database applications, slide presentation applications, drawing or computer-aided application programs, etc.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 8 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 800 on the single integrated circuit (chip). Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

The computing device 800 may also have one or more input device(s) 812 such as a keyboard, a mouse, a pen, a sound or voice input device, a touch or swipe input device, etc. The output device(s) 814 such as a display, speakers, a printer, etc. may also be included. The aforementioned devices are examples and others may be used. The computing device 800 may include one or more communication connections 816 allowing communications with other computing devices 850. Examples of suitable communication connections 816 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 804, the removable storage device 809, and the non-removable storage device 810 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 800. Any such computer storage media may be part of the computing device 800. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

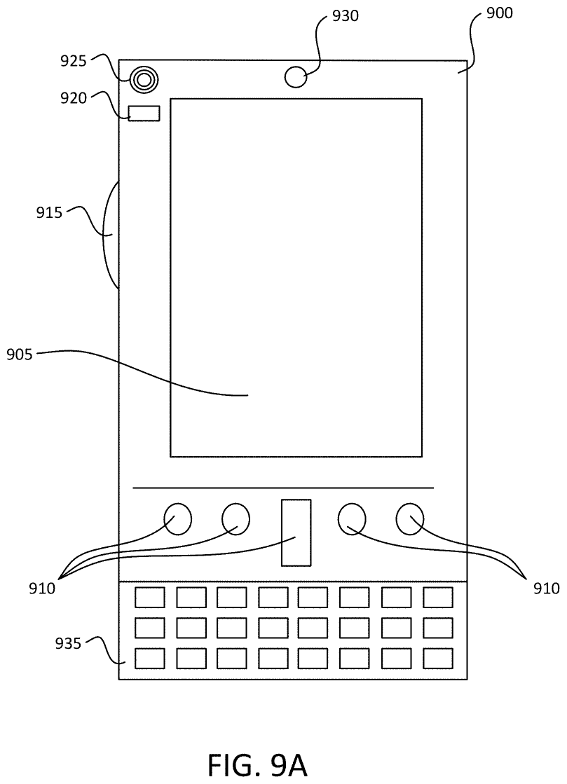

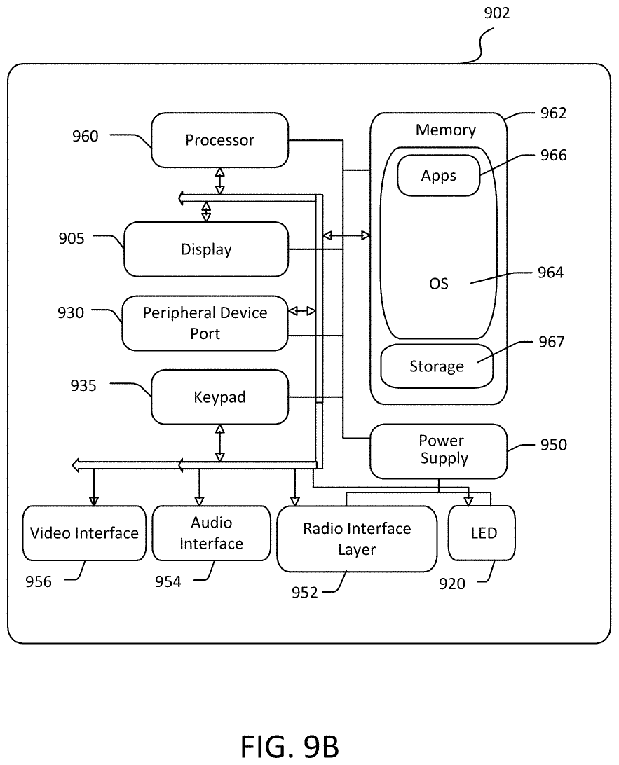

FIGS. 9A and 9B illustrate a mobile computing device 900, for example, a mobile telephone, a smart phone, wearable computer (such as, for example, a smart watch), a tablet computer, a laptop computer, and the like, with which embodiments of the disclosure may be practiced. In some aspects, the client may be a mobile computing device. With reference to FIG. 9A, one aspect of a mobile computing device 900 for implementing the aspects is illustrated. In a basic configuration, the mobile computing device 900 is a handheld computer having both input elements and output elements. The mobile computing device 900 typically includes a display 905 and one or more input buttons 910 that allow the user to enter information into the mobile computing device 900. The display 905 of the mobile computing device 900 may also function as an input device (e.g., a touch screen display). If included, an optional side input element 915 allows further user input. The side input element 915 may be a rotary switch, a button, or any other type of manual input element. In alternative aspects, mobile computing device 900 may incorporate more or less input elements. For example, the display 905 may not be a touch screen in some embodiments. In yet another alternative embodiment, the mobile computing device 900 is a portable phone system, such as, for example, a cellular phone. The mobile computing device 900 may also include an optional keypad 935. Optional keypad 935 may be a physical keypad or a “soft” keypad generated on the touch screen display. In various embodiments, the output elements include the display 905 for showing a graphical user interface (GUI), a visual indicator 920 (e.g., a light emitting diode), and/or an audio transducer 925 (e.g., a speaker). In some aspects, the mobile computing device 900 incorporates a vibration transducer for providing the user with tactile feedback. In yet another aspect, the mobile computing device 900 incorporates input and/or output ports, such as, for example, an audio input (e.g., a microphone jack), an audio output (e.g., a headphone jack), and a video output (e.g., a HDMI port) for sending signals to or receiving signals from an external device.

FIG. 9B is a block diagram illustrating the architecture of one aspect of a mobile computing device. That is, the mobile computing device 900 can incorporate a system (e.g., an architecture) 902 to implement some aspects. In one embodiment, the system 902 is implemented as a “smart phone” capable of running one or more applications (e.g., browser, e-mail, calendaring, contact managers, messaging clients, games, and media clients/players). In some aspects, the system 902 is integrated as a computing device, such as, for example, an integrated personal digital assistant (PDA) and wireless phone.

One or more application programs 966 may be loaded into the memory 962 and run on or in association with the operating system 964. Examples of the application programs include phone dialer programs, e-mail programs, personal information management (PIM) programs, word processing programs, spreadsheet programs, Internet browser programs, messaging programs, and so forth. The system 902 also includes a non-volatile storage area 968 within the memory 962. The non-volatile storage area 968 may be used to store persistent information that should not be lost if the system 902 is powered down. The application programs 966 may use and store information in the non-volatile storage area 968, such as, for example, e-mail or other messages used by an e-mail application, and the like. A synchronization application (not shown) also resides on the system 902 and is programmed to interact with a corresponding synchronization application resident on a host computer to keep the information stored in the non-volatile storage area 968 synchronized with corresponding information stored at the host computer. As should be appreciated, other applications may be loaded into the memory 962 and run on the mobile computing device 900 described herein (e.g., search engine, extractor module, relevancy ranking module, answer scoring module, etc.).

The system 902 has a power supply 970, which may be implemented as one or more batteries. The power supply 970 might further include an external power source, such as, for example, an AC adapter or a powered docking cradle that supplements or recharges the batteries.

The system 902 may also include a radio interface layer 972 that performs the function of transmitting and receiving radio frequency communications. The radio interface layer 972 facilitates wireless connectivity between the system 902 and the “outside world,” via a communications carrier or service provider. Transmissions to and from the radio interface layer 972 are conducted under control of the operating system 964. In other words, communications received by the radio interface layer 972 may be disseminated to the application programs 966 via the operating system 964, and vice versa.

The visual indicator 920 may be used to provide visual notifications, and/or an audio interface 974 may be used for producing audible notifications via the audio transducer 925. In the illustrated embodiment, the visual indicator 920 is a light emitting diode (LED) and the audio transducer 925 is a speaker. These devices may be directly coupled to the power supply 970 so that when activated, they remain on for a duration dictated by the notification mechanism even though the processor 960 and other components might shut down for conserving battery power. The LED may be programmed to remain on indefinitely until the user takes action to indicate the powered-on status of the device. The audio interface 974 is used to provide audible signals to and receive audible signals from the user. For example, in addition to being coupled to the audio transducer 925, the audio interface 974 may also be coupled to a microphone to receive audible input, such as to facilitate a telephone conversation. In accordance with embodiments of the present disclosure, the microphone may also serve as an audio sensor to facilitate control of notifications, as will be described below. The system 902 may further include a video interface 976 that enables an operation of an on-board camera 930 to record still images, video stream, and the like.

A mobile computing device 900 implementing the system 902 may have additional features or functionality. For example, the mobile computing device 900 may also include additional data storage devices (removable and/or non-removable) such as, for example, magnetic disks, optical disks, or tape. Such additional storage is illustrated in FIG. 9B by the non-volatile storage area 968.

Data/information generated or captured by the mobile computing device 900 and stored via the system 902 may be stored locally on the mobile computing device 900, as described above, or the data may be stored on any number of storage media that may be accessed by the device via the radio interface layer 952 or via a wired connection between the mobile computing device 900 and a separate computing device associated with the mobile computing device 900, for example, a server computer in a distributed computing network, such as the Internet. As should be appreciated such data/information may be accessed via the mobile computing device 900 via the radio interface layer 952 or via a distributed computing network. Similarly, such data/information may be readily transferred between computing devices for storage and use according to well-known data/information transfer and storage means, including electronic mail and collaborative data/information sharing systems.

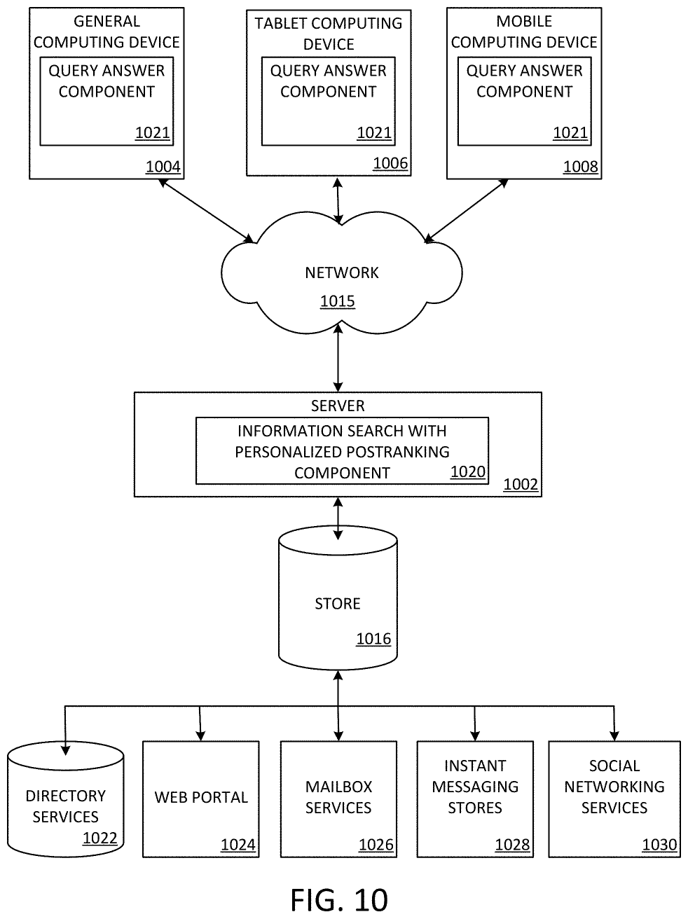

FIG. 10 illustrates one aspect of the architecture of a system for processing data received at a computing system from a remote source, such as, for example, a personal computer 1004, tablet computing device 1006, or mobile computing device 1008, as described above. Content displayed at server device 1002 may be stored in different communication channels or other storage types. For example, various documents may be stored using a directory service 1022, a web portal 1024, a mailbox service 1026, an instant messaging store 1028, or a social networking site 1030. A query answer component 1021 may be employed by a client that communicates with server device 1002, and/or an information search with personalized post-ranking component 1020 may be employed by server device 1002. The server device 1002 may provide data to and from a client computing device such as, for example, a personal computer 1004, a tablet computing device 1006 and/or a mobile computing device 1008 (e.g., a smart phone) through a network 1015. By way of example, the computer system described above may be embodied in a personal computer 1004, a tablet computing device 1006 and/or a mobile computing device 1008 (e.g., a smart phone). Any of these embodiments of the computing devices may obtain content from the store 1016, in addition to receiving graphical data useable to be either pre-processed at a graphic-originating system, or post-processed at a receiving computing system.

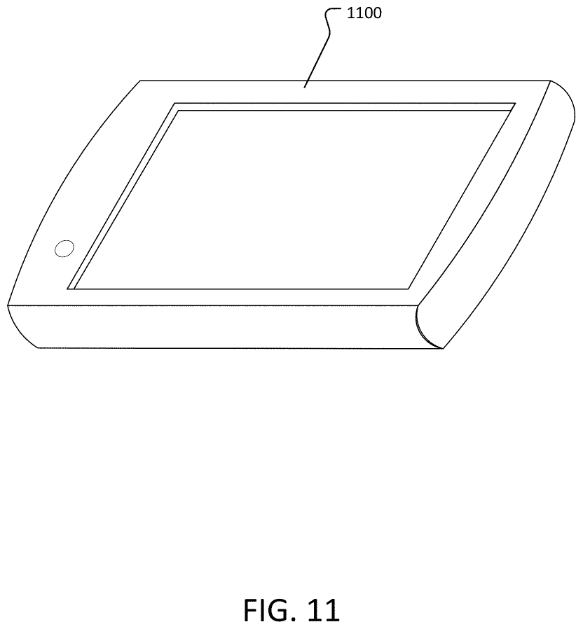

FIG. 11 illustrates an exemplary tablet computing device 1100 that may execute one or more aspects disclosed herein. In addition, the aspects and functionalities described herein may operate over distributed systems (e.g., cloud-based computing systems), where application functionality, memory, data storage and retrieval and various processing functions may be operated remotely from each other over a distributed computing network, such as, for example, the Internet or an intranet. User interfaces and information of various types may be displayed via on-board computing device displays or via remote display units associated with one or more computing devices. For example user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A computer-implemented method for ranking and post-ranking a search result, the method comprising:
receiving a query input for a search;
generating a search result based on the received query, wherein the search result includes two or more distinct entries of information;
ranking the two or more distinct entries of information of the search result based on global optimization functions;
determining a personal affinity of a requestor of the query;
post-ranking the ranked two or more distinct entries of information of the search result based on the personal affinity;
providing the post-ranked two or more distinct entries of information.

2. The computer-implemented method of claim 1, the method further comprising determining an intent of the query input;
post-ranking the ranked two or more distinct entries of information when at least one condition is satisfied, wherein the at least one condition includes:
the requestor is logged in;
the personal affinity of the requestor is determinable;
an intent of the query input matches the personal affinity; and
a number of the entries of information of the search result classified as the same as the personal affinity satisfies a predetermined condition.

3. The computer-implemented method of claim 1, further comprising:
partitioning the ranked two or more distinct entries of information into two or more partitions of a list of the search result; and
post-ranking the partitioned two or more distinct entries within respective partitions.

4. The computer-implemented method of claim 1, further comprising:
extracting one or more entities from the query input;
registering the one or more entities to a knowledge base, wherein the knowledge base associates the one or more entities to one or more categories of information; and
determining a personal affinity of the requestor based on the one or more categories of the information associated with the requestor in the knowledge base;
storing the personal affinity in a user profile of the requestor; and
determining a personal affinity of a requestor of the query based on the user profile.

5. The computer-implemented method of claim 1, wherein the ranked two or more distinct entries of information includes two or more ordered rank portions of the search result, and the post-ranking of the ranked two or more distinct entries of information limits re-ranking of the ranked two or more distinct entries within the respective two or more ordered rank portions.

6. The computer-implemented method of claim 1, wherein the determining the personal affinity includes an access to a user profile in a knowledge base implemented as a graph database.

7. The computer-implemented method of claim 1, wherein the ranked two or more distinct entries of the search result are in a first sequence and the post-ranked two or more distinct entries of the search result are in a second sequence, and wherein the ranked two or more distinct entries and the post-ranked two or more distinct entries include an identical set of two or more distinct entries and the first sequence and the second sequence are distinct.

8. The computer-implemented method of claim 3, wherein the partitioning is based on confidence level scores of the search result, wherein the confidence level scores indicate how closely the two or more distinct entries of the search result match the personal affinity of the requestor.

9. The computer-implemented method of claim 4, wherein the knowledge base is a graph database including two or more nodes and at least one edge connecting the nodes, and wherein the two or more nodes store one or more categories and the one or more entities.

10. The computer-implemented method of claim 5, wherein the two or more ordered rank portions of the search result is based on the global optimization functions and the post-ranked two or more distinct entries of information within respective two or more ordered rank portions of the search result is based on the personal affinity of the requestor.

11. A computing device, comprising:
at least one processing unit; and
at least one memory storing computer executable instructions for storing data to a graph database, the instructions when executed by the at least one processing unit causing the computing device to perform steps of:
receiving a query input for a search;
generating a search result based on the received query, wherein the search result includes two or more distinct entries of information;
ranking the two or more distinct entries of information of the search result based on global optimization functions as a first ranked list;
determining a personal affinity of a requestor of the query;
post-ranking the ranked two or more distinct entries of information of the search result based on the personal affinity as a second ranked list;
providing the second ranked list.

12. The computing device, the steps further comprising:
determining an intent of the query input;
post-ranking the ranked two or more distinct entries of information when at least one condition is satisfied, wherein the at least one condition includes:
the requestor is logged in;
the personal affinity of the requestor is determinable;
an intent of the query input matches the personal affinity; and
a number of the entries of information of the search result classified as the same as the personal affinity satisfies a predetermined condition.

13. The computing device, the steps further comprising:
partitioning the ranked two or more distinct entries of information into two or more partitions of a list of the search result; and
post-ranking the partitioned two or more distinct entries within respective partitions.

14. The computing device, the steps further comprising:
extracting one or more entities from the query input;
registering the one or more entities to a knowledge base, wherein the knowledge base associates the one or more entities to one or more categories of information; and
determining a personal affinity of the requestor based on the one or more categories of the information associated with the requestor in the knowledge base;
storing the personal affinity in a user profile of the requestor; and
determining a personal affinity of a requestor of the query based on the user profile.

15. A computer-readable storage medium storing computer executable instructions for searching information, the instructions when executed by at least one processing unit, cause the at least one processing unit to perform steps of:
receiving a first query input for a search from a first requestor through a first user interaction;
receiving a second query input for the search from a second requestor through a second user interaction, wherein the first query input and the second query input are identical;
transmitting the first query input;
transmitting the second query input;
receiving a first ordered list of a search result based on the first query, wherein the first ordered list includes two or more ranked distinct entries of information based on a first personal affinity of the first requestor;
receiving a second ordered list of the search result based on the second query, wherein the second ordered list is based on a second personal affinity of second requestor;
displaying the first ordered list and the second ordered list, wherein the second ordered list is distinct from the first ordered list.

16. The computer-readable storage medium of claim 15, wherein the first ordered list and the second ordered list respectively include two or more rank portions and the distinction between the first ordered list and the second ordered list is ordering of entries of information within respective two or more rank portions.

17. The computer-readable storage medium of claim 15, wherein the first user interaction occurs when the first requestor is logged in and the second user interaction occurs when the second requestor is logged out.

18. The computer-readable storage medium of claim 15, wherein the first user interaction occurs when the first requestor is logged in and the second user interaction occurs when the second requestor is logged in.

19. The computer-readable storage medium of claim 15, further comprising:
extracting entities from the first query;
storing the extracted entities from the first query in a knowledge base, wherein the knowledge base is a graph database associating one or more categories and the extracted entities with one or more predicate;
determining the first personal affinity based on at least the one or more categories from the knowledge base;
providing the first personal affinity.

20. The computer-readable storage medium of claim 19, further comprising:
post-ranking the received first ordered list based on the first personal affinity; and
displaying the post-ranked list of the search result.
